(19) United States
(12) Patent Application Publication
(10) Pub. No.: US 2026/0112379 A1
(43) Pub. Date: Apr. 23, 2026

(54) METHOD OF PROCESSING SPEECH STREAM, METHOD OF TRAINING DEEP LEARNING MODEL, AND AGENT

(71) Applicant: Beijing Baidu Netcom Science Technology Co., Ltd., Beijing (CN)

(72) Inventors: Sipan LI, Beijing (CN); Tao SUN, Beijing (CN); Lei JIA, Beijing (CN)

(21) Appl. No.: 19/425,191

(22) Filed: Dec. 18, 2025

(30) Foreign Application Priority Data
Mar. 20, 2025 (CN) 202510334495.X

(51) Int. Cl. G10L 21/02; G06N 3/045; G06N 3/0895; G10L 25/30

(52) U.S. Cl. CPC G10L 21/02; G06N 3/045; G06N 3/0895; G10L 25/30

(57) ABSTRACT

A method of processing a speech stream, which is related to the field of artificial intelligence technology, and more particularly to the fields of deep learning, speech processing, and voice conversion technologies, and includes: performing a feature extraction on a first speech frame sequence in a speech stream to be processed to obtain a first speech feature, where the first speech frame sequence overlaps with at least one second speech frame in a second speech frame sequence, and the second speech frame sequence precedes the first speech frame sequence in the speech stream; fusing, based on an attention mechanism, the first speech feature and a second speech feature determined based on the second speech frame sequence to obtain a speech fusion feature; and converting the speech fusion feature based on a preset speech attribute to obtain converted speech data corresponding to the first speech frame sequence.

This application claims the benefit of priority to Chinese Patent Application No. 202510334495.X, filed on Mar. 20, 2025. The entire contents of this application are hereby incorporated herein by reference.

### TECHNICAL FIELD

The present disclosure relates to a field of artificial intelligence technology, in particular to deep learning, speech processing, and speech conversion technology, and more specifically, to a method of processing a speech stream, a method of training a deep learning model, a device, a medium, and an agent.

### BACKGROUND

With a rapid development of artificial intelligence technology, speech conversion may be achieved based on artificial intelligence. For example, speech conversion may convert speech features of a source speaker into speech features of a target speaker, while preserving semantic content of the source speaker's speech.

### SUMMARY

The present disclosure provides a method of processing a speech stream, a method of training a deep learning model, a device, a medium, and an agent.

According to an aspect of the present disclosure, a method of processing a speech stream is provided, including: performing a feature extraction on a first speech frame sequence in a speech stream to be processed to obtain a first speech feature, where the first speech frame sequence overlaps with at least one second speech frame in a second speech frame sequence, and the second speech frame sequence precedes the first speech frame sequence in the speech stream; fusing, based on an attention mechanism, the first speech feature and a second speech feature determined based on the second speech frame sequence to obtain a speech fusion feature; and converting the speech fusion feature based on a preset speech attribute to obtain converted speech data corresponding to the first speech frame sequence.

According to another aspect of the present disclosure, a method of training a deep learning model is provided, a speech feature extraction network of the deep learning model includes a feature extraction layer and a feature fusion layer, and the method includes: acquiring a sample speech stream, where a first sample speech frame sequence in the sample speech stream overlaps with at least one second speech frame in a second sample speech frame sequence, and the second sample speech frame sequence precedes the first sample speech frame sequence in the sample speech stream; performing a feature extraction on the first sample speech frame sequence using the feature extraction layer to obtain a first sample speech feature; masking the first sample speech feature to obtain a masked sample speech feature; performing an attention-based feature fusion using the feature fusion layer on the masked sample speech feature and a second sample speech feature determined based on the second sample speech frame sequence, to obtain a sample speech fusion feature; and training the speech feature extraction network based on a self-supervised mechanism using the sample speech fusion feature to obtain a trained deep learning model.

According to another aspect of the present disclosure, an artificial intelligence agent is provided, including: an input module, configured to receive input information; a processing module, configured to determine a target task based on the input information received by the input module, determine a large model based on the target task, and obtain output information by invoking the large model to execute the methods provided according to embodiments of the present disclosure; and an output module, configured to output the output information obtained by the processing module.

According to another aspect of the present disclosure, an electronic device is provided, including: at least one processor; and a memory communicatively connected to the at least one processor, where the memory stores instructions executable by the at least one processor, and the instructions, when executed by the at least one processor, cause the at least one processor to perform the methods as described above.

According to another aspect of the present disclosure, a non-transitory computer-readable storage medium having computer instructions stored thereon is provided, where the computer instructions are used to cause a computer to execute the methods as described above.

It should be understood that the content described in this section is not intended to identify key or important features of embodiments of the present disclosure, nor is it intended to limit the scope of the present disclosure. Other features of the present disclosure will become readily clear from the following description.

### BRIEF DESCRIPTION OF THE DRAWINGS

The drawings are used for a better understanding of the solution and do not constitute a limitation on the present disclosure, in which:

FIG. 1 schematically illustrates an exemplary system architecture to which a method and apparatus of processing a speech stream and a method and apparatus of training a deep learning model are applied according to embodiments of the present disclosure;

FIG. 2 schematically illustrates a flowchart of a method of processing a speech stream according to embodiments of the present disclosure;

FIG. 3 schematically illustrates a schematic diagram of fusing a window speech feature and a first speech feature based on the attention mechanism to obtain a speech fusion feature according to embodiments of the present disclosure;

FIG. 4 schematically illustrates a schematic diagram of performing attention masking on an input feature based on a sliding of a preset window according to embodiments of the present disclosure;

FIG. 5 schematically illustrates a flowchart of processing a speech stream to obtain converted speech data according to embodiments of the present disclosure;

FIG. 6 schematically illustrates a flowchart of a method of training a deep learning model according to embodiments of the present disclosure;

FIG. 7 schematically illustrates a block diagram of an apparatus of processing a speech stream according to embodiments of the present disclosure;

FIG. 8 schematically illustrates a block diagram of an apparatus of training a deep learning model according to embodiments of the present disclosure;

FIG. 9 schematically illustrates a structural block diagram of an artificial intelligence agent according to an embodiment of the present disclosure; and

FIG. 10 schematically illustrates a schematic block diagram of an example electronic device for implementing a method of processing a speech stream and a method of training a deep learning model according to embodiments of the present disclosure.

### DETAILED DESCRIPTION OF EMBODIMENTS

Exemplary embodiments of the present disclosure are described below with reference to the accompanying drawings, which include various details of embodiments to facilitate understanding and should be considered merely exemplary. Therefore, it should be recognized by those of ordinary skill in the art that various changes and modifications may be made to embodiments described herein without departing from the scope and spirit of the present disclosure. Similarly, for clarity and conciseness, descriptions of well-known functions and structures are omitted in the following description.

In the technical solutions of the present disclosure, the acquisition, storage, and application of user personal information involved are all conducted in compliance with the provisions of relevant laws and regulations, necessary confidentiality measures have been implemented, and they do not violate public order and good morals.

With a rapid development of artificial intelligence technology, speech conversion may be achieved based on artificial intelligence. For example, speech conversion may convert speech features of a source speaker into speech features of a target speaker, while preserving semantic content of the source speaker's speech.

In related speech conversion methods, it is usually necessary to input complete source speech data to achieve conversion of the complete source speech data and output of complete target speech data. However, in scenarios involving infinite streaming speech data, where the data is input continuously and in real-time, these related speech conversion methods struggle to meet low-latency requirements and often result in issues such as semantic loss, and disjointed or unnatural prosody.

FIG. 1 illustrates an exemplary system architecture to which a method and apparatus of processing a speech stream and a method and apparatus of training a deep learning model are applied according to embodiments of the present disclosure.

It should be noted that FIG. 1 merely illustrates an example of a system architecture to which embodiments of the present disclosure may be applied, to assist those skilled in the art in understanding the technical content of the present disclosure. This does not mean that embodiments of the present disclosure cannot be used for other devices, systems, environments, or scenarios. For example, in another embodiment, an exemplary system architecture to which the method and apparatus of processing a speech stream and the method and apparatus of training a deep learning model are applied may include terminal devices, the terminal devices may implement the method and apparatus of processing a speech stream and the method and apparatus of training a deep learning model provided by embodiments of the present disclosure without interacting with a server.

As shown in FIG. 1, the system architecture 100 according to the embodiment may include terminal devices 101, 102, 103, a network 104, and a server 105. The network 104 serves as a medium for providing communication links between the terminal devices 101, 102, 103 and the server 105. The network 104 may include various types of connections, such as wired and/or wireless communication links, etc.

The terminal devices 101, 102, 103 may be used by the user to interact with the server 105 via the network 104 to receive or send messages, etc. Various communication client applications may be installed on the terminal devices 101, 102, 103, such as knowledge reading applications, web browser applications, search applications, instant messaging tools, email clients, and/or social platform software (for example only).

The terminal devices 101, 102, 103 may be various electronic devices equipped with display screens and capable of supporting web browsing, including but not limited to smartphones, tablet computers, laptop portable computers, desktop computers, and the like.

The server 105 may be a server that provides various services, such as a background management server that supports content browsed by the user using the terminal devices 101, 102, 103 (for example only). The background management server may perform analysis and other processing on received data such as user requests, and feedback processing results (e.g., webpages, information, or data obtained or generated according to user requests) to the terminal devices.

The server may be a cloud server, also referred to as a cloud computing server or cloud host, which is a type of host product within a cloud computing service system. It addresses the shortcomings of traditional physical hosts and VPS services ("Virtual Private Server", or "VPS" for short), such as high management difficulty and weak business scalability. The server may also be a server in a distributed system or a server integrated with blockchain technology.

It should be noted that the method of processing a speech stream and the method of training a deep learning model provided by embodiments of the present disclosure may generally be performed by the terminal device 101, 102, or 103. Accordingly, the apparatus of processing a speech stream and the apparatus of training a deep learning model provided by embodiments of the present disclosure may also be arranged in the terminal device 101, 102, or 103.

Alternatively, the method of processing a speech stream and the method of training a deep learning model provided by embodiments of the present disclosure may generally be performed by the server 105. Accordingly, the apparatus of processing a speech stream and the apparatus of training a deep learning model provided by embodiments of the present disclosure may generally be arranged in the server 105. Alternatively, the method of processing a speech stream and the method of training a deep learning model provided by embodiments of the present disclosure may be performed by a server or server cluster different from the server 105 and capable of communicating with the terminal devices 101, 102, 103 and/or the server 105. Accordingly, the apparatus of processing a speech stream and the apparatus of training a deep learning model provided by embodiments of the present disclosure may be arranged in a server or server cluster different from the server 105 and capable of communicating with the terminal devices 101, 102, 103 and/or the server 105.

For example, when a user is reading an e-book online, the terminal devices 101, 102, 103 may acquire target content in the e-book pointed to by the user's line of sight, and then send the acquired target content to the server 105. The server 105 may analyze the target content to determine feature information of the target content; predict content of interest to the user based on the feature information of the target content; and extract the content of interest to the user. Alternatively, a server or server cluster capable of communicating with the terminal devices 101, 102, 103 and/or the server 105 may analyze the target content and ultimately achieve extraction of the content of interest to the user.

It should be understood that the numbers of terminal devices, networks, and servers in FIG. 1 are merely illustrative. According to implementation needs, there may be any number of terminal devices, networks, and servers.

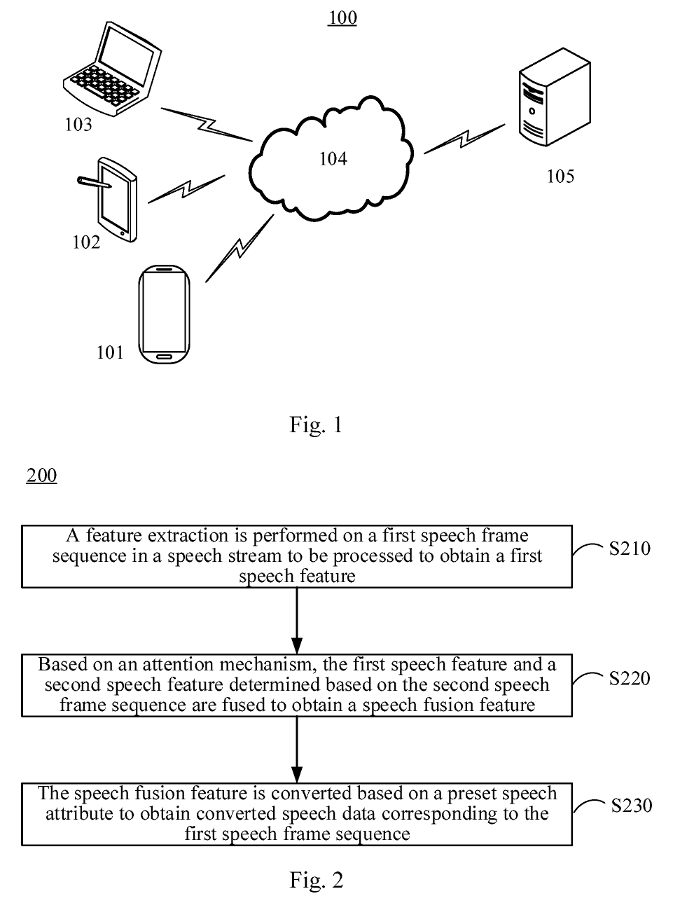

FIG. 2 schematically illustrates a flowchart of a method of processing a speech stream according to embodiments of the present disclosure.

As shown in FIG. 2, the method 200 includes operations S210 to S230.

In operation S210, a feature extraction is performed on a first speech frame sequence in a speech stream to be processed to obtain a first speech feature, and the first speech frame sequence overlaps with at least one second speech frame in a second speech frame sequence, and the second speech frame sequence precedes the first speech frame sequence in the speech stream.

In operation S220, based on an attention mechanism, the first speech feature and a second speech feature determined based on the second speech frame sequence are fused to obtain a speech fusion feature.

In operation S230, the speech fusion feature is converted based on a preset speech attribute to obtain converted speech data corresponding to the first speech frame sequence.

According to embodiments of the present disclosure, the speech stream to be processed may refer to a speech stream on which a speech conversion is to be performed. The speech stream to be processed is transmitted and processed in real-time in a continuous streaming form and may include a plurality of speech frames. For example, the speech stream to be processed may include a real-time communication speech stream, an online live streaming speech stream, etc. An input duration of the speech stream to be processed may be several minutes, tens of minutes, several hours, or even longer.

According to an embodiment of the present disclosure, in response to receiving a speech stream signal to be processed, the continuous speech stream to be processed may be segmented into a plurality of speech frames. Furthermore, the plurality of speech frames may be processed sequentially into a plurality of speech data packets, each speech data packet may refer to a frame sequence including multiple speech frames. The speech stream to be processed may be processed in batches in real-time based on the plurality of speech data packets. This allows for immediate analysis and processing upon receiving a certain amount of the speech stream signal to be processed, without waiting for the complete speech stream data to be processed, thereby enabling low-latency real-time conversion.

According to embodiments of the present disclosure, the first speech frame sequence may refer to a current speech data packet being processed in the speech stream to be processed. The second speech frame sequence may refer to a previous speech data packet adjacent to the current speech data packet in the speech stream to be processed. The second speech frame sequence precedes the first speech frame sequence in the speech stream, and the first speech frame sequence overlaps with at least one speech frame in the second speech frame sequence. In other words, the first speech frame sequence includes at least one speech frame from the preceding adjacent speech frame sequence (the second speech frame sequence) in the speech stream.

In an embodiment, for example, the second speech frame sequence may include speech frames 1 to 20 (e.g., denoted as P1-P20), and the first speech frame sequence may include speech frames 11 to 30 (e.g., denoted as P11-P30). It should be noted that those skilled in the art may reasonably set the number of speech frames overlapping between the first speech frame sequence and the second speech frame sequence according to actual requirements or application scenarios, which is not specifically limited herein.

According to embodiments of the present disclosure, a feature extraction may be performed on the second speech frame sequence in the speech stream to be processed to obtain a second speech feature. A feature extraction may be performed on the first speech frame sequence in the speech stream to be processed to obtain a first speech feature. The first speech feature and the second speech feature may be fused based on an attention mechanism to obtain a speech fusion feature.

It may be understood that since the first speech frame sequence includes at least one speech frame from the second speech frame sequence, performing feature extraction on the first speech frame sequence allows the first speech feature to include preceding speech information from the second speech frame sequence. The first speech feature and the second speech feature may be fused based on the attention mechanism to obtain the speech fusion feature, which enables the speech fusion feature to maintain speech coherence and semantic integrity based on the preceding speech information from the second speech frame sequence.

According to embodiments of the present disclosure, in the application scenario of speech conversion, the speech stream to be processed may refer to source speech stream data from a source speaker. The preset speech attribute may represent characteristics of a target speaker such as timbre features, pitch features, speech style, etc. For example, the preset speech attribute may include the target speaker's gender, age, timbre, emotional style, etc. The source speech stream data may be converted based on the preset speech attribute to obtain converted speech stream data, thereby achieving the conversion of the speaker from the source speaker to the target speaker while preserving the semantics and prosody of the source speech stream data.

According to embodiments of the present disclosure, the speech fusion feature may represent speech information of the first speech frame sequence and preceding speech information of the first speech frame sequence. The speech fusion feature may be converted based on the preset speech attribute to obtain converted speech data corresponding to the first speech frame sequence. This enables the obtained converted speech data to express the speech content of the first speech frame sequence based on the preset speech attribute under conditions of natural speech prosody as well as accurate and complete semantics, thereby achieving high-quality speech conversion on the speech stream.

According to embodiments of the present disclosure, by processing the speech stream to be processed in batches in real-time based on a plurality of speech frame sequences, analysis and processing may be performed immediately upon receiving a preset data length of the speech stream signal to be processed, without waiting for the complete speech stream data to be processed, thereby enabling low-latency real-time interaction. The first speech frame sequence includes at least one speech frame from the preceding adjacent speech frame sequence (the second speech frame sequence) in the speech stream, therefore, performing feature extraction on the first speech frame sequence allows the first speech feature to include preceding speech information from the second speech frame sequence. The first speech feature and the second speech feature may be fused based on an attention mechanism to obtain the speech fusion feature, which enables the speech fusion feature to maintain speech coherence and semantic integrity based on the preceding speech information from the second speech frame sequence. The speech fusion feature may be converted based on the preset speech attribute to obtain converted speech data corresponding to the first speech frame sequence, which enables the obtained converted speech data to express the speech content of the first speech frame sequence based on the preset speech attribute under conditions of natural speech prosody as well as accurate and complete semantics. Thus, by performing real-time processing and conversion on the current data packet in the speech stream, high-quality, low-latency speech conversion operations on the speech stream may be achieved.

It should be noted that the method of processing a speech stream provided by embodiments of the present disclosure may be applied to real-time speech interaction application scenarios, such as intelligent customer service, speech communication, online live streaming, etc. The method of processing a speech stream provided by embodiments of the present disclosure does not limit the application scenario.

According to embodiments of the present disclosure, the fusing, based on an attention mechanism, the first speech feature and a second speech feature determined based on the second speech frame sequence to obtain a speech fusion feature includes: masking the second speech feature based on a window mechanism to obtain a window speech feature; and fusing the window speech feature and the first speech feature based on the attention mechanism to obtain the speech fusion feature.

According to embodiments of the present disclosure, the second speech feature may be masked based on a window mechanism to obtain a window speech feature. For example, part of the second speech feature may be masked based on a preset window to obtain the window speech feature. Alternatively, at least one of first sub-features in the first speech feature may be masked based on the preset window to determine, from the first speech feature based on the preset window, the sub-features that require contextual semantic attention calculation among a plurality of first speech sub-features, thereby enhancing the information completeness and accuracy of the speech fusion feature. Those skilled in the art may reasonably set the preset window according to actual needs or application scenarios, which is not specifically limited herein.

According to embodiments of the present disclosure, the window speech feature and the first speech feature may be fused based on the attention mechanism to obtain the speech fusion feature.

It may be understood that the second speech feature may represent preceding speech information adjacent to the first speech feature. The window-based masking operation may effectively capture local, adjacent preceding speech information in the second speech feature while improving computational efficiency. On this basis, by fusing the window speech feature and the first speech feature based on the attention mechanism to obtain the speech fusion feature, it is ensured that the speech fusion feature maintain speech coherence and semantic integrity based on the local, adjacent preceding speech information in the second speech feature.

According to embodiments of the present disclosure, the second speech feature includes a plurality of second sub-features arranged in sequence, and the first speech feature includes a first target sub-feature. Masking the second speech feature based on a window mechanism to obtain a window speech feature includes: determining, from the plurality of second sub-features, at least one window sub-feature adjacent to the first target sub-feature based on a preset window; and masking one or more second sub-features in the second speech feature other than the at least one window sub-feature to obtain the window speech feature corresponding to the first target sub-feature.

According to embodiments of the present disclosure, the first target sub-feature in the first speech feature may be determined based on the length of the preset window. For example, the first speech feature may include five sequentially arranged first sub-features. The length of the preset window may be, for example, 2. Then, the first two of the five first sub-features may be determined as first target sub-features.

According to embodiments of the present disclosure, the at least one window sub-feature in the second speech feature may be determined based on the length of the preset window. For example, the second speech feature may include five sequentially arranged second sub-features, and the length of the preset window may be, for example, 2. Then, the last two of the five second sub-features that are adjacent to the first target sub-feature may be determined as window sub-features.

As an example, second sub-features in the second speech feature other than the at least one window sub-feature may be masked to obtain the window speech feature corresponding to the first target sub-feature.

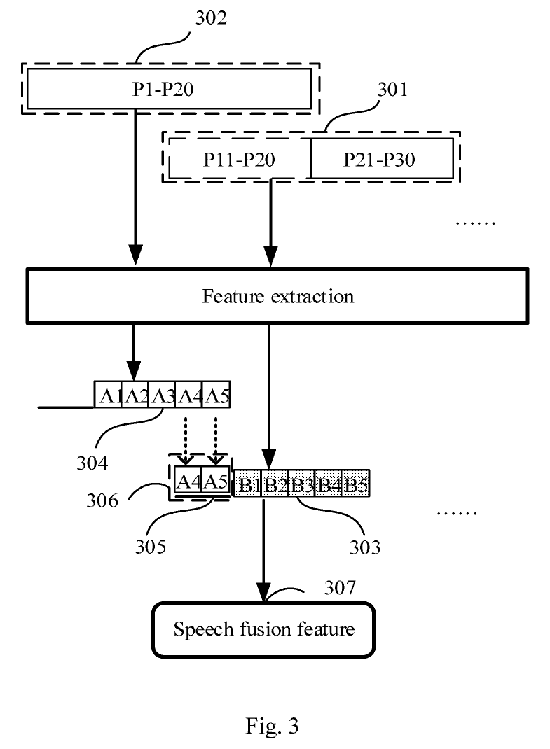

FIG. 3 schematically illustrates a schematic diagram of fusing a window speech feature and a first speech feature based on the attention mechanism to obtain a speech fusion feature according to embodiments of the present disclosure.

As shown in FIG. 3, the second speech frame sequence 302 may, for example, include speech frames 1 to 20 (e.g., denoted as P1-P20) in the speech stream to be processed. The first speech frame sequence 301 may, for example, include speech frames 11 to 30 (e.g., denoted as P11-P30) in the speech stream to be processed. The second speech frame sequence 302 precedes the first speech frame sequence 301 in the speech stream, and the first speech frame sequence 301 overlaps with speech frames 11 to 20 in the second speech frame sequence 302. The overlapping speech frames may be, for example, P11-P20.

As shown in FIG. 3, feature extraction may be performed on the second speech frame sequence 302 to obtain a second speech feature 304. The second speech feature 304 may include a plurality of sequentially arranged second sub-features, which may, for example, be denoted as A1, A2, A3, A4, and A5, respectively. Feature extraction may be performed on the first speech frame sequence 301 to obtain a first speech feature 303. The first speech feature 303 may include a plurality of sequentially arranged first sub-features B1, B2, B3, B4, and B5.

As shown in FIG. 3, the length of the preset window 305 may be 2. Based on the preset window 305, first sub-features B1 and B2 among the plurality of first sub-features may be determined as first target sub-features. Based on the preset window 305, second sub-features A4 and A5 among the plurality of second sub-features that are adjacent to first sub-features B1 and B2 may be determined as window sub-features. On this basis, second sub-features (i.e., A1-A3) in the second speech feature 304 other than A4 and A5 may be masked to obtain a window speech feature 306 corresponding to the first target sub-features.

As shown in FIG. 3, the window speech feature 306 and the first speech feature 303 may be fused based on an attention mechanism to obtain a speech fusion sub-feature corresponding to the first target sub-feature B1. The speech fusion feature 307 may be determined based on a fusion result of the speech fusion sub-features respectively corresponding to the plurality of first sub-features B1 to B5.

According to embodiments of the present disclosure, masking one or more second sub-features in the second speech feature other than at least one window sub-feature to obtain the window speech feature corresponding to the target sub-feature includes: masking the one or more second sub-features in the second speech feature other than the at least one window sub-feature to obtain at least one first window sub-feature, where the second speech feature includes the at least one first window sub-feature; determining at least one second window sub-feature from one or more first sub-features arranged before the first target sub- feature in the first speech feature; and determining the window speech feature based on the at least one first window sub-feature and the at least one second window sub-feature.

According to embodiments of the present disclosure, in an attention mechanism, a query vector (Query), a key vector (Key), and a value vector (Value) may be derived via linear transformation from input features. For example, the window speech feature and the first speech feature may be used as input features, and the query vector, the key vector, and the value vector may be obtained based on the second speech feature and parameter matrices WQ, WK, and WV, respectively.

According to embodiments of the present disclosure, an attention mask may be applied to the input second speech feature based on sliding a preset window. This restricts the attention calculation range for a first target sub-feature to a local range defined by the preset window that is adjacent to the first target sub-feature. Consequently, each first sub-feature only needs to attend to its local preceding speech information. Since information such as prosody, intonation, and timbre in a speech stream signal usually varies within a relatively short duration, the sliding-window-based attention mask helps effectively capture these local preceding features. This, in turn, may better preserve speech coherence and semantic integrity.

According to an embodiment of the present disclosure, one or more second sub-features in the second speech feature other than at least one window sub-feature may be masked to obtain at least one first window sub-feature, where the second speech feature includes the at least one first window sub-feature. At least one second window sub-feature may be determined from one or more first sub-features arranged before the first target sub-feature in the first speech feature. The window speech feature may be determined based on the at least one first window sub-feature and the at least one second window sub-feature.

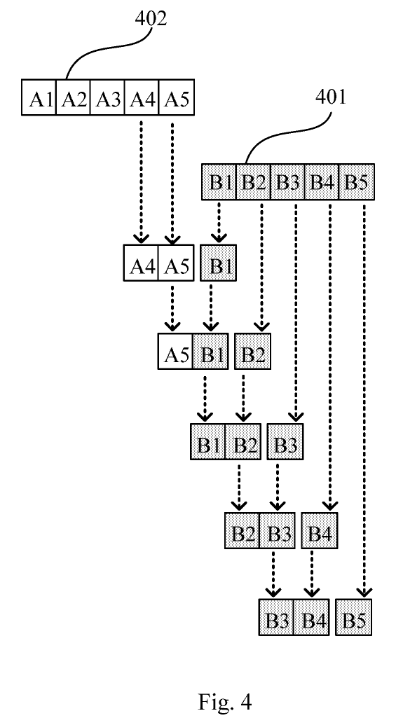

FIG. 4 schematically illustrates a schematic diagram of performing attention masking on an input feature based on a sliding of a preset window according to embodiments of the present disclosure.

As shown in FIG. 4, the window length of the preset window may, for example, be set to 2, and the sliding stride may, for example, be set to 1. The first speech feature 401 include a plurality of sequentially arranged first sub-features B1 to B5. The second speech feature 402 include a plurality of sequentially arranged second sub-features A1 to A5.

As shown in FIG. 4, for example, the second speech feature 402 is masked based on a window mechanism, with the first sub-feature B1 serving as the first target sub-feature. Based on the preset window, second sub-features A1, A2, and A3 in the second speech feature 402 are masked. Consequently, the window sub-features corresponding to the first sub-feature B1 are determined to be the second sub-features A4 and A5. Using the second sub-features A4 and A5 as the key vector and the value vector, and the first sub-feature B1 as the query vector, an attention calculation is performed to obtain a speech fusion sub-feature corresponding to the first sub-feature B1. Subsequently, with the first sub-feature B2 serving as the first target sub-feature, and based on the preset window, second sub-features A1, A2, A3, and A4 in the second speech feature 402 are masked. The window sub-features corresponding to the first sub-feature B2 are thus determined to be the second sub-feature A5 and the first sub-feature B1. Using these window sub-features, namely, the second sub-feature A5 and the first sub-feature B1, as the key vector and the value vector, and the first sub-feature B2 as the query vector, an attention calculation is performed to obtain a speech fusion sub-feature corresponding to the first sub-feature B2. It should be understood that the window sub-features corresponding to the first sub-feature B3 may be the first sub-features B1 and B2. Using the first sub-features B1 and B2 as the key vector and the value vector, and the first sub-feature B3 as the query vector, an attention calculation is performed to obtain a speech fusion sub-feature corresponding to the first sub-feature B3. The window sub-features corresponding to the first sub-feature B4 may be the first sub-features B2 and B3. Using the first sub-features B2 and B3 as the key vector and the value vector, and the first sub-feature B4 as the query vector, an attention calculation is performed to obtain a speech fusion sub-feature corresponding to the first sub-feature B4. The window sub-features corresponding to the first sub-feature B5 may be the first sub-features B3 and B4. Using the first sub-features B3 and B4 as the key vector and the value vector, and the first sub-feature B5 as the query vector, an attention calculation is performed to obtain a speech fusion sub-feature corresponding to the first sub-feature B5. In this way, respective speech fusion sub-features corresponding to the plurality of first sub-features B1 to B5 may be obtained. The speech fusion feature may be determined by fusing the plurality of speech fusion sub-features. For example, the plurality of speech fusion sub-features may be fused based on a normalization algorithm to obtain the speech fusion feature.

According to embodiments of the present disclosure, performing a feature extraction on a first speech frame sequence in a speech stream to be processed to obtain a first speech feature includes: performing at least one convolution operation on the first speech frame sequence based on a first convolution kernel to obtain an initial speech feature; and performing at least one convolution operation on the initial speech feature based on a second convolution kernel to obtain the first speech feature, where a stride of the first convolution kernel is greater than a stride of the second convolution kernel.

According to an embodiment of the present disclosure, each speech frame in the first speech frame sequence may be processed to obtain a corresponding mel-spectrum for each speech frame. A mel-spectrum converts the spectral representation of an audio signal to the Mel frequency scale to simulate human auditory perception of frequency.

In an embodiment, the mel-spectrum corresponding to each speech frame in the first speech frame sequence may be input into a convolutional network for feature extraction to obtain the first speech feature.

As an example, the aforementioned convolutional network may include: a first convolutional layer based on the first convolution kernel and a second convolutional layer based on the second convolution kernel, where the stride of the first convolution kernel is greater than the stride of the second convolution kernel.

In an embodiment, the kernel size of the first convolution kernel may, for example, be set to 5, and its stride may, for example, be set to 2. The kernel size of the second convolution kernel may, for example, be set to 5, and its stride may, for example, be set to 1. For example, at least one convolution operation may be performed on the first speech frame sequence based on the first convolution kernel to obtain the initial speech feature. Then, at least one convolution operation may be performed on the initial speech feature based on the second convolution kernel to obtain the first speech feature.

According to an embodiment of the present disclosure, the convolution operation may be causal convolution. Causal convolution may be used for processing time-series data, it utilizes information only from the current and previous time steps for convolution, thereby avoiding interference from future information. This type of convolution may introduce positional information without requiring positional encoding.

According to embodiments of the present disclosure, the convolutional network may introduce positional information based on at least one causal convolutional layer. By controlling the number of convolutional layers and the kernel sizes within the layers, the receptive field of the convolutional network may be effectively expanded, enabling the convolutional network to capture broader contextual information. By controlling the stride of the convolution kernels, computational efficiency may be optimized, reducing the latency of real-time speech stream data processing.

According to embodiments of the present disclosure, converting the speech fusion feature based on a preset speech attribute to obtain converted speech data corresponding to the first speech frame sequence includes: performing an upsampling convolution operation on the speech fusion feature to obtain a target fusion feature; performing a feature fusion on the preset speech attribute and the target fusion feature to obtain a converted speech feature; and determining the converted speech data corresponding to the first speech frame sequence based on the converted speech feature.

According to an embodiment of the present disclosure, the speech fusion feature may be input into an encoder for an upsampling convolution operation to obtain a target fusion feature, such that the data volume of the target fusion feature matches that of the first speech frame sequence. For example, the data volume of the first speech frame sequence may be 20 frames. Feature extraction performed on the first speech frame sequence may yield a first speech feature with a data volume of 5 frames. The first speech feature and the second speech feature determined based on the second speech frame sequence may be fused based on an attention mechanism to obtain a speech fusion feature with a data volume of 5 frames. An upsampling convolution operation may then be performed on the speech fusion feature to obtain a target fusion feature with a data volume of 20 frames.

According to embodiments of the present disclosure, in the application scenario of speech conversion, the preset speech attribute may represent characteristics such as the timbre, pitch, and speech style of a target speaker. The preset speech attribute and the speech fusion feature may be fused to obtain the converted speech feature. The fusion method may be based on an attention mechanism, for example, which is not specifically limited herein.

According to an embodiment of the present disclosure, the converted speech feature may be input into a decoder to obtain the converted speech data corresponding to the first speech frame sequence. In this way, the conversion from the source speaker to the target speaker may be achieved while preserving the semantics and prosody of the first speech frame sequence.

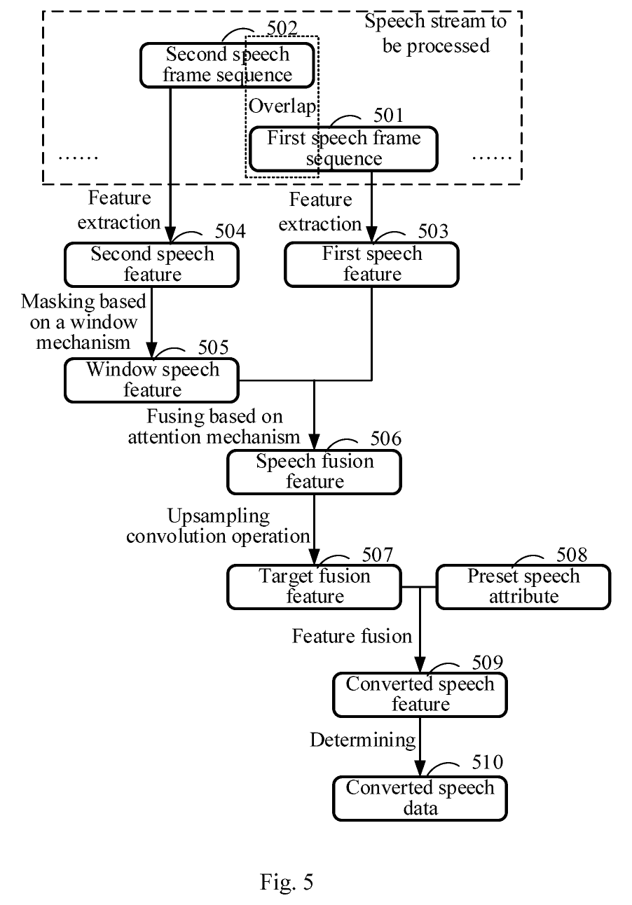

FIG. 5 schematically illustrates a flowchart of processing a speech stream to obtain converted speech data according to embodiments of the present disclosure.

As shown in FIG. 5, feature extraction may be performed on a second speech frame sequence 502 in a speech stream to be processed, to obtain a second speech feature 504. Feature extraction may be performed on a first speech frame sequence 501 in the speech stream to be processed, to obtain a first speech feature 503. The second speech frame sequence 502 precedes the first speech frame sequence 501 in the speech stream, and the first speech frame sequence 501 overlaps with at least one second speech frame in the second speech frame sequence 502.

As shown in FIG. 5, the second speech feature 504 may be masked based on a window mechanism to obtain a window speech feature 505. The window speech feature 505 and the first speech feature 503 may be fused based on an attention mechanism to obtain a speech fusion feature 506.

As shown in FIG. 5, an upsampling convolution operation may be performed on the speech fusion feature 506 to obtain a target fusion feature 507. The preset speech attribute 508 and the target fusion feature 507 may be fused to obtain a converted speech feature 509. Based on the converted speech feature 509, converted speech data 510 corresponding to the first speech frame sequence 501 may be determined.

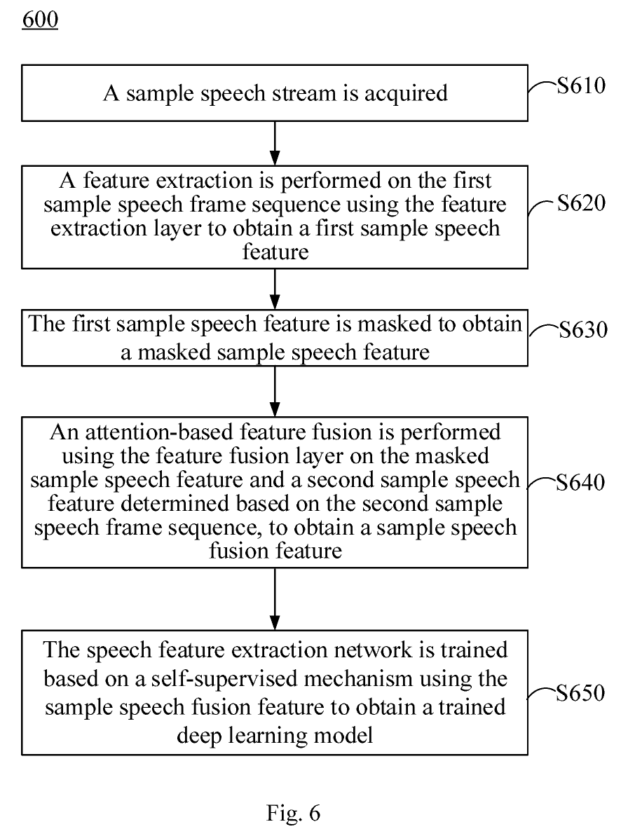

FIG. 6 schematically illustrates a flowchart of a method of training a deep learning model according to embodiments of the present disclosure.

As shown in FIG. 6, the method 600 includes operations S610 to S650.

In operation S610, a sample speech stream is acquired, where a first sample speech frame sequence in the sample speech stream overlaps with at least one second speech frame in a second sample speech frame sequence, and the second sample speech frame sequence precedes the first sample speech frame sequence in the sample speech stream.

In operation S620, a feature extraction is performed on the first sample speech frame sequence using the feature extraction layer to obtain a first sample speech feature.

In operation S630, the first sample speech feature is masked to obtain a masked sample speech feature.

In operation S640, an attention-based feature fusion is performed using the feature fusion layer on the masked sample speech feature and a second sample speech feature determined based on the second sample speech frame sequence, to obtain a sample speech fusion feature.

In operation S650, the speech feature extraction network is trained based on a self-supervised mechanism using the sample speech fusion feature to obtain a trained deep learning model.

According to embodiments of the present disclosure, the first sample speech frame sequence may be determined from the obtained sample speech stream. The first sample speech frame sequence overlaps with at least one second speech frame in the second sample speech frame sequence, and the second sample speech frame sequence precedes the first sample speech frame sequence in the sample speech stream.

According to embodiments of the present disclosure, a feature extraction layer may be used to extract features from the first sample speech frame sequence to obtain the first sample speech feature. The feature extraction layer may be used to extract features from the second sample speech frame sequence to obtain the second sample speech feature. The first sample speech feature may be randomly masked to obtain the masked sample speech feature. The feature fusion layer may be used to perform attention-based feature fusion on the masked sample speech feature and the second sample speech feature to obtain the sample speech fusion feature.

According to embodiments of the present disclosure, the sample speech fusion feature may be used as an input to a deep learning model to train the deep learning model to predict masked features, and the model parameters may be optimized through a loss function to obtain a trained deep learning network. By combining random masking with a prediction task, the deep learning model can learn, through a self-supervised mechanism, the speech feature of the first sample speech frame sequence and its neighboring preceding speech features. This enables the model to accurately characterize the prosodic features and semantic features of the first sample speech frame sequence.

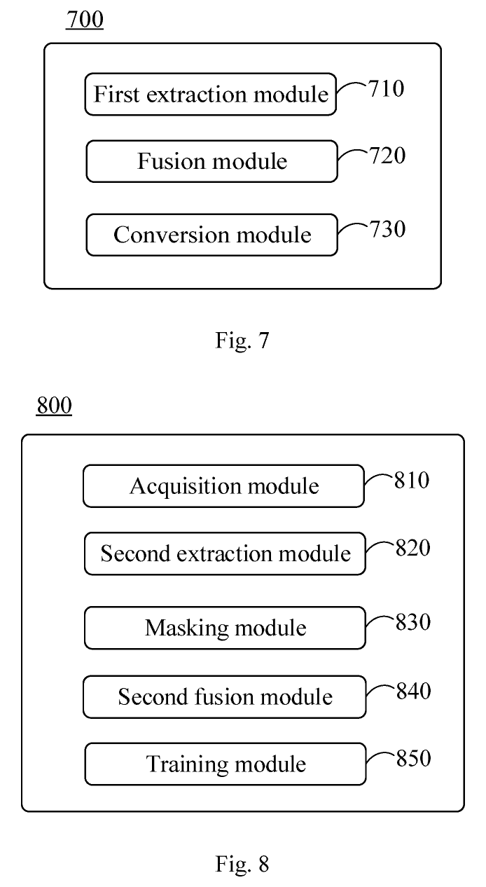

FIG. 7 schematically illustrates a block diagram of an apparatus of processing a speech stream according to embodiments of the present disclosure.

As shown in FIG. 7, the apparatus 700 of processing a speech stream may include a first extraction module 710, a fusion module 720, and a conversion module 730.

The first extraction module 710 is configured to perform a feature extraction on a first speech frame sequence in a speech stream to be processed to obtain a first speech feature, where the first speech frame sequence overlaps with at least one second speech frame in a second speech frame sequence, and the second speech frame sequence precedes the first speech frame sequence in the speech stream.

The fusion module 720 is used to fuse, based on an attention mechanism, the first speech feature and a second speech feature determined based on the second speech frame sequence to obtain a speech fusion feature.

The conversion module 730 is used to convert the speech fusion feature based on a preset speech attribute to obtain converted speech data corresponding to the first speech frame sequence.

According to embodiments of the present disclosure, the fusion module may include a masking sub-module and a first fusion sub-module.

The masking sub-module is used to mask the second speech feature based on a window mechanism to obtain a window speech feature.

The first fusion sub-module is used to fuse the window speech feature and the first speech feature based on the attention mechanism to obtain the speech fusion feature.

According to embodiments of the present disclosure, the second speech feature includes a plurality of second sub-features arranged in sequence, and the first speech feature includes a first target sub-feature. The masking sub-module may include a determination unit and a masking unit.

The determination unit is used to determine at least one window sub-feature adjacent to the first target sub-feature from the plurality of second sub-features based on a preset window.

The masking unit is used to mask one or more second sub-features in the second speech feature other than the at least one window sub-feature to obtain the window speech feature corresponding to the first target sub-feature.

According to embodiments of the present disclosure, the masking unit may include a masking sub-unit, a first determination sub-unit, and a second determination sub-unit.

The masking sub-unit is used to mask the one or more second sub-features in the second speech feature other than the at least one window sub-feature to obtain at least one first window sub-feature, where the second speech feature includes the at least one first window sub-feature.

The first determination sub-unit is used to determine at least one second window sub-feature from one or more first sub-features arranged before the first target sub-feature in the first speech feature.

The second determination sub-unit is used to determine the window speech feature based on the at least one first window sub-feature and the at least one second window sub-feature.

According to embodiments of the present disclosure, the first extraction module may include a first convolution sub-module and a second convolution sub-module.

The first convolution sub-module is used to perform at least one convolution operation on the first speech frame sequence based on a first convolution kernel to obtain an initial speech feature.

The second convolution sub-module is used to perform at least one convolution operation on the initial speech feature based on a second convolution kernel to obtain the first speech feature, where a stride of the first convolution kernel is greater than a stride of the second convolution kernel.

According to embodiments of the present disclosure, the conversion module may include an upper sampling sub-module, a second fusion sub-module, and a conversion sub-module.

The upper sampling sub-module is used to perform an upsampling convolution operation on the speech fusion feature to obtain a target fusion feature.

The second fusion sub-module is used to perform a feature fusion on the preset speech attribute and the target fusion feature to obtain a converted speech feature.

The conversion sub-module is used to determine the converted speech data corresponding to the first speech frame sequence based on the converted speech feature.

FIG. 8 schematically illustrates a schematic diagram of an apparatus of training a deep learning model according to embodiments of the present disclosure.

As shown in FIG. 8, the apparatus 800 of training a deep learning model may include an acquisition module 810, a second extraction module 820, a masking module 830, a second fusion module 840, and a training module 850.

The acquisition module 810 is used to acquire a sample speech stream, where a first sample speech frame sequence in the sample speech stream overlaps with at least one second speech frame in a second sample speech frame sequence, and the second sample speech frame sequence precedes the first sample speech frame sequence in the sample speech stream.

The second extraction module 820 is used to perform a feature extraction on the first sample speech frame sequence using the feature extraction layer to obtain a first sample speech feature.

The masking module 830 is used to mask the first sample speech feature to obtain a masked sample speech feature.

The second fusion module 840 is used to perform an attention-based feature fusion using the feature fusion layer on the masked sample speech feature and a second sample speech feature determined based on the second sample speech frame sequence, to obtain a sample speech fusion feature.

The training module 850 is used to train the speech feature extraction network based on a self-supervised mechanism using the sample speech fusion feature to obtain a trained deep learning model.

It should be noted that the part of the apparatus of processing a speech stream in embodiments of the present disclosure corresponds to the part of the method of processing a speech stream in embodiments of the present disclosure. For descriptions related to the part of the apparatus of processing a speech stream, specific reference may be made to the part of the method of processing a speech stream, which will not be repeated here.

The part of the apparatus of training a deep learning model in embodiments of the present disclosure corresponds to the part of the method of training a deep learning model in embodiments of the present disclosure. For descriptions related to the part of the apparatus of training a deep learning model, specific reference may be made to the part of the method of training a deep learning model, which will not be repeated here.

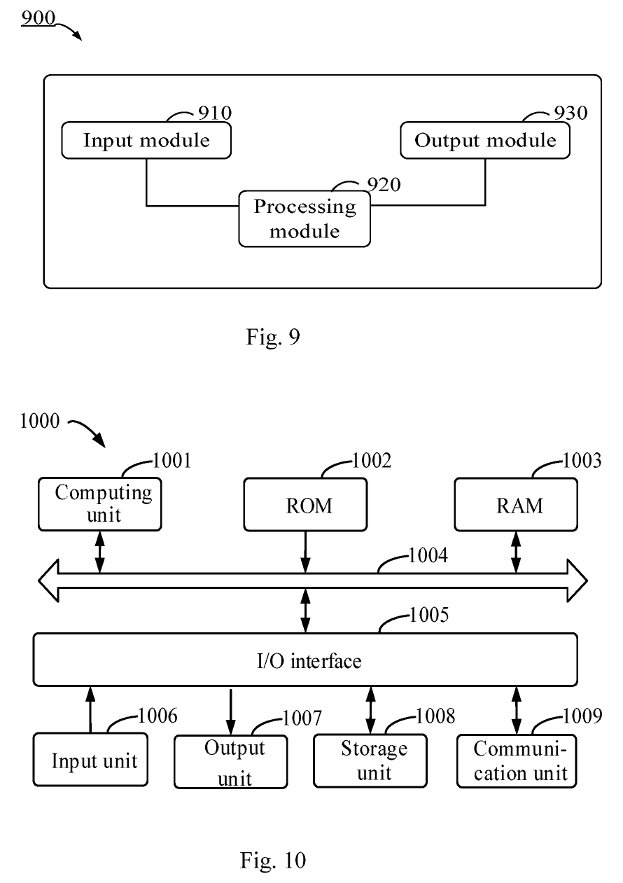

FIG. 9 schematically illustrates a structural block diagram of an artificial intelligence agent according to embodiments of the present disclosure.

In an embodiment of the present disclosure, as shown in FIG. 9, the artificial intelligence (AI) agent 900 may include an input module 910, a processing module 920, and an output module 930.

The input module 910 is used to receive a speech stream to be processed.

The processing module 920 is used to acquire converted speech data by invoking a trained deep learning model to execute the method of processing a speech stream provided by embodiments of the present disclosure, based on the speech stream to be processed received by the input module.

The output module 930 is used to output the converted speech data obtained by the processing module.

According to embodiments of the present disclosure, the input module 910 is used for receiving or sensing information such as queries, requests, instructions, signals, or data from the external world (e.g., a user or the external environment), and converting them into a format understandable and processable by the AI agent 900. The input module 910 is the primary interface for interaction between the AI agent 900 and the external world. It enables the AI agent 900 to efficiently and accurately acquire necessary “sensory” information from the external world and respond to this information.

In an example, the input module 910 may input the speech stream to be processed as described above.

In an example, the processing module 920 is the core support for the AI agent 900 to handle complex tasks. The processing module 920 may execute the method of processing a speech stream as described above.

In an example, the performance of the processing module 920 may be closely related to the large model upon which the AI agent 900 is based. To fully leverage the capabilities of the large model, the internal structure of the processing module 920 can be designed to be highly configurable and extensible to meet various types of tasks and demands in real-world scenarios.

In an example, after the AI agent 900 acquires the speech stream to be processed, the processing module 920 may utilize the trained deep learning model to process the first speech frame sequence within the speech stream to be processed, obtain the converted speech data, and then transmit the converted speech data to the output module 930.

It can be understood that although large language models possess excellent language understanding and generation capabilities, like humans, they are limited in the tasks they can solve without the aid of any tools. When the AI agent 900 is endowed with tool invocation capabilities, it can accomplish tasks such as performing mathematical operations with a calculator, conducting data analysis with Python, or providing weather forecasts with a search engine.

In an example, the output module 930 may output the converted speech data as described above.

The AI agent 900 according to embodiments of the present disclosure can simply and effectively enhance the level of intelligence, as well as improve flexibility and versatility.

According to embodiments of the present disclosure, the present disclosure further provides an electronic device, a readable storage medium, and a computer program product.

According to an embodiment of the present disclosure, an electronic device includes: at least one processor; and a memory communicatively connected to the at least one processor; where the memory stores instructions executable by the at least one processor, and the instructions, when executed by the at least one processor, cause the at least one processor to perform the method as described above.

According to an embodiment of the present disclosure, a non-transitory computer-readable storage medium has computer instructions stored thereon, where the computer instructions are used to cause a computer to execute the method as described above.

According to an embodiment of the present disclosure, a computer program product includes a computer program, where the computer program, when executed by a processor, implements the method as described above.

FIG. 10 schematically illustrates a schematic block diagram of an exemplary electronic device 1000 that can be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital assistants, cellular telephones, smartphones, wearable devices, and other similar computing devices. The components shown herein, their connections and relationships, and their functions are meant to be exemplary only, and are not intended to limit the implementation of the present disclosure described and/or claimed herein.

As shown in FIG. 10, the device 1000 includes a computing unit 1001, which may perform various appropriate actions and processes in accordance with computer programs stored in a read-only memory (ROM) 1002 or computer programs loaded from a storage unit 1008 into a random-access memory (RAM) 1003. Various programs and data required for the operation of the device 1000 may also be stored in the RAM 1003. The computing unit 1001, the ROM 1002, and the RAM 1003 are connected to each other via a bus 1004. An input/output (I/O) interface 1005 is also connected to the bus 1004.

A plurality of components in the device 1000 are connected to the I/O interface 1005, including: an input unit 1006, such as a keyboard, a mouse, or the like; an output unit 1007, such as various types of displays, speakers, or the like; a storage unit 1008, such as a magnetic disk, an optical disk, or the like; and a communication unit 1009, such as a network card, a modem, a wireless communication transceiver, or the like. The communication unit 1009 allows the device 1000 to exchange information/data with other devices via computer networks such as the Internet and/or various telecommunication networks.

The computing unit 1001 may be various general-purpose and/or special-purpose processing components with processing and computing capabilities. Examples of the computing unit 1001 include, but are not limited to, central processing units (CPUs), graphics processing units (GPUs), various specialized artificial intelligence (AI) computing chips, various computing units that run machine learning model algorithms, digital signal processors (DSPs), and any suitable processors, controllers, microcontrollers, and the like. The computing unit 1001 executes the various methods and processes described above, such as the method of processing a speech stream and the method of training a deep learning model. For example, in some embodiments, the method of processing a speech stream and the method of training a deep learning model may be implemented as computer software programs, which are tangibly contained in a machine-readable medium, such as the storage unit 1008. In some embodiments, part or all of the computer program may be loaded and/or installed onto the device 1000 via the ROM 1002 and/or the communication unit 1009. When the computer program is loaded into the RAM 1003 and executed by the computing unit 1001, one or more steps of the method of processing a speech stream and the method of training a deep learning model described above may be executed. Alternatively, in other embodiments, the computing unit 1001 may be configured to execute the method of processing a speech stream and the method of training a deep learning model by any other appropriate means (for example, by means of firmware).

Various embodiments of the systems and technologies described herein may be implemented in digital electronic circuitry, integrated circuitry, field-programmable gate arrays (FPGAs), application specific integrated circuits (ASICs), application specific standard products (ASSPs), system on a chip (SOC), complex programmable logic devices (CPLDs), computer hardware, firmware, software, and/or combinations thereof. These various embodiments may include: being implemented in one or more computer programs, which are executable and/or interpretable on a programmable system including at least one programmable processor. The programmable processor may be a special-purpose or general-purpose programmable processor, which may receive data and instructions from, and transmit data and instructions to, a storage system, at least one input device, and at least one output device.

Program codes for implementing the methods of the present disclosure may be written in any combination of one or more programming languages. These program codes may be provided to a processor or controller of a general-purpose computer, a special-purpose computer, or other programmable data processing apparatus, such that the program codes, when executed by the processor or controller, cause the functions/operations specified in the flowcharts and/or block diagrams to be implemented. The program codes may execute entirely on the machine, partly on the machine, as a stand-alone software package partly on the machine and partly on a remote machine, or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of the machine-readable storage medium would include electrical connections based on one or more wires, a portable computer disk, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In order to provide interaction with a user, the systems and techniques described here may be implemented on a computer that has: a display device (for example, a CRT (cathode ray tube) or LCD (liquid crystal display) monitor) for displaying information to the user; and a keyboard and a pointing device (for example, a mouse or a trackball) by which the user may provide input to the computer. Other kinds of devices may also be used to provide interaction with a user; for example, feedback provided to the user may be any form of sensory feedback (for example, visual feedback, auditory feedback, or tactile feedback); and input from the user may be received in any form, including acoustic, speech, or tactile input.

The systems and techniques described here may be implemented in a computing system that includes back-end components (e.g., as a data server), or that includes middleware components (e.g., an application server), or that includes front-end components (e.g., a client computer having a graphical user interface or a web browser through which a user may interact with an implementation of the systems and techniques described here), or any combination of such back-end, middleware, or front-end components. The components of the system may be interconnected by any form or medium of digital data communication (e.g., a communication network). Examples of communication networks include: local area network (LAN), wide area network (WAN), and the Internet.

A computer system may include a client and a server. The client and the server are generally remote from each other and typically interact through a communication network. The client-server relationship is established by computer programs running on the respective computers and having a client-server relationship with each other. The server may be a cloud server, a server of a distributed system, or a server combined with blockchain.

It should be understood that various forms of flows shown above may be used, with steps reordered, added, or removed. For example, the steps described in the present disclosure may be executed in parallel, sequentially, or in different orders, as long as the desired results of the technical solutions disclosed in the present disclosure are achieved. There is no specific limitation herein.

The foregoing specific implementations do not constitute a limitation on the protection scope of the present disclosure. It should be understood by those skilled in the art that various modifications, combinations, sub-combinations, and substitutions may be made according to design requirements and other factors. Any modifications, equivalent replacements, and improvements made within the spirit and principles of the present disclosure shall be included within the protection scope of the present disclosure.

What is claimed is:

1. A method of processing a speech stream, the method comprising:
performing a feature extraction on a first speech frame sequence in a speech stream to be processed to obtain a first speech feature, wherein the first speech frame sequence overlaps with at least one second speech frame in a second speech frame sequence, and the second speech frame sequence precedes the first speech frame sequence in the speech stream;
fusing, based on an attention mechanism, the first speech feature and a second speech feature determined based on the second speech frame sequence to obtain a speech fusion feature; and
converting the speech fusion feature based on a preset speech attribute to obtain converted speech data corresponding to the first speech frame sequence.

2. The method according to claim 1, wherein the fusing, based on an attention mechanism, the first speech feature and a second speech feature determined based on the second speech frame sequence to obtain a speech fusion feature comprises:
masking the second speech feature based on a window mechanism to obtain a window speech feature; and
fusing the window speech feature and the first speech feature based on the attention mechanism to obtain the speech fusion feature.

3. The method according to claim 2, wherein the second speech feature comprises a plurality of second sub-features arranged in sequence, and the first speech feature comprises a first target sub-feature;
wherein the masking the second speech feature based on a window mechanism to obtain a window speech feature comprises:
determining, from the plurality of second sub-features, at least one window sub-feature adjacent to the first target sub-feature based on a preset window; and
masking one or more second sub-features in the second speech feature other than the at least one window sub-feature to obtain the window speech feature corresponding to the first target sub-feature.

4. The method according to claim 3, wherein the masking one or more second sub-features in the second speech feature other than the at least one window sub-feature to obtain the window speech feature corresponding to the first target sub-feature comprises:
masking the one or more second sub-features in the second speech feature other than the at least one window sub-feature to obtain at least one first window sub-feature, wherein the second speech feature comprises the at least one first window sub-feature;
determining at least one second window sub-feature from one or more first sub-features arranged before the first target sub-feature in the first speech feature; and
determining the window speech feature based on the at least one first window sub-feature and the at least one second window sub-feature.

5. The method according to claim 1, wherein the performing a feature extraction on a first speech frame sequence in a speech stream to be processed to obtain a first speech feature comprises:
performing at least one convolution operation on the first speech frame sequence based on a first convolution kernel to obtain an initial speech feature; and
performing at least one convolution operation on the initial speech feature based on a second convolution kernel to obtain the first speech feature, wherein a stride of the first convolution kernel is greater than a stride of the second convolution kernel.

6. The method according to claim 1, wherein the converting the speech fusion feature based on a preset speech attribute to obtain converted speech data corresponding to the first speech frame sequence comprises:
performing an upsampling convolution operation on the speech fusion feature to obtain a target fusion feature;
performing a feature fusion on the preset speech attribute and the target fusion feature to obtain a converted speech feature; and
determining the converted speech data corresponding to the first speech frame sequence based on the converted speech feature.

7. The method according to claim 5, wherein the converting the speech fusion feature based on a preset speech attribute to obtain converted speech data corresponding to the first speech frame sequence comprises:
performing an upsampling convolution operation on the speech fusion feature to obtain a target fusion feature;
performing a feature fusion on the preset speech attribute and the target fusion feature to obtain a converted speech feature; and
determining the converted speech data corresponding to the first speech frame sequence based on the converted speech feature.

8. A method of training a deep learning model, wherein a speech feature extraction network of the deep learning model comprises a feature extraction layer and a feature fusion layer, and the method comprises:
acquiring a sample speech stream, wherein a first sample speech frame sequence in the sample speech stream overlaps with at least one second speech frame in a second sample speech frame sequence, and the second sample speech frame sequence precedes the first sample speech frame sequence in the sample speech stream;
performing a feature extraction on the first sample speech frame sequence using the feature extraction layer to obtain a first sample speech feature;
masking the first sample speech feature to obtain a masked sample speech feature;
performing, using the feature fusion layer, an attention-based feature fusion on the masked sample speech feature and a second sample speech feature determined based on the second sample speech frame sequence, to obtain a sample speech fusion feature; and
training the speech feature extraction network based on a self-supervised mechanism using the sample speech fusion feature to obtain a trained deep learning model.

9. An agent, comprising:
an input module, configured to receive input information;
a processing module, configured to determine a target task based on the input information received by the input module, determine a large model based on the target task, and obtain output information by invoking the large model to implement the method according to claim 1; and
an output module, configured to output the output information obtained by the processing module.

10. An agent, comprising:
an input module, configured to receive input information;
a processing module, configured to determine a target task based on the input information received by the input module, determine a large model based on the target task, and obtain output information by invoking the large model to implement the method according to claim 8; and
an output module, configured to output the output information obtained by the processing module.

11. An electronic device, comprising:
at least one processor; and
a memory communicatively connected to the at least one processor,
wherein the memory stores instructions executable by the at least one processor, and the instructions, when executed by the at least one processor, are configured to cause the at least one processor to at least:
perform a feature extraction on a first speech frame sequence in a speech stream to be processed to obtain a first speech feature, wherein the first speech frame sequence overlaps with at least one second speech frame in a second speech frame sequence, and the second speech frame sequence precedes the first speech frame sequence in the speech stream;
fuse, based on an attention mechanism, the first speech feature and a second speech feature determined based on the second speech frame sequence to obtain a speech fusion feature; and
convert the speech fusion feature based on a preset speech attribute to obtain converted speech data corresponding to the first speech frame sequence.

12. The electronic device according to claim 11, wherein the instructions are further configured to cause the at least one processor to at least:
mask the second speech feature based on a window mechanism to obtain a window speech feature; and
fuse the window speech feature and the first speech feature based on the attention mechanism to obtain the speech fusion feature.

13. The electronic device according to claim 12, wherein the second speech feature comprises a plurality of second sub-features arranged in sequence, and the first speech feature comprises a first target sub-feature;
wherein the instructions are further configured to cause the at least one processor to at least:
determine, from the plurality of second sub-features, at least one window sub-feature adjacent to the first target sub-feature based on a preset window; and
mask one or more second sub-features in the second speech feature other than the at least one window sub-feature to obtain the window speech feature corresponding to the first target sub-feature.

14. The electronic device according to claim 13, wherein the instructions are further configured to cause the at least one processor to at least:
mask the one or more second sub-features in the second speech feature other than the at least one window sub-feature to obtain at least one first window sub-feature, wherein the second speech feature comprises the at least one first window sub-feature;
determine at least one second window sub-feature from one or more first sub-features arranged before the first target sub-feature in the first speech feature; and
determine the window speech feature based on the at least one first window sub-feature and the at least one second window sub-feature.

15. The electronic device according to claim 11, wherein the instructions are further configured to cause the at least one processor to at least:
perform at least one convolution operation on the first speech frame sequence based on a first convolution kernel to obtain an initial speech feature; and
perform at least one convolution operation on the initial speech feature based on a second convolution kernel to obtain the first speech feature, wherein a stride of the first convolution kernel is greater than a stride of the second convolution kernel.

16. The electronic device according to claim 11, wherein the instructions are further configured to cause the at least one processor to at least:
perform an upsampling convolution operation on the speech fusion feature to obtain a target fusion feature;
perform a feature fusion on the preset speech attribute and the target fusion feature to obtain a converted speech feature; and
determine the converted speech data corresponding to the first speech frame sequence based on the converted speech feature.

17. The electronic device according to claim 15, wherein the instructions are further configured to cause the at least one processor to at least:
perform an upsampling convolution operation on the speech fusion feature to obtain a target fusion feature;
perform a feature fusion on the preset speech attribute and the target fusion feature to obtain a converted speech feature; and
determine the converted speech data corresponding to the first speech frame sequence based on the converted speech feature.

18. An electronic device, comprising:
at least one processor; and
a memory communicatively connected to the at least one processor,
wherein the memory stores instructions executable by the at least one processor, and the instructions, when executed by the at least one processor, are configured to cause the at least one processor to implement the method according to claim 8.

19. A non-transitory computer-readable storage medium having computer instructions stored thereon, wherein the computer instructions are configured to cause a computer to implement the method according to claim 1.

20. A non-transitory computer-readable storage medium having computer instructions stored thereon, wherein the computer instructions are configured to cause a computer to implement the method of claim 8.
